(19) United States
(12) Patent Application Publication
(10) Pub. No.: US 2019/0316384 A1
(43) Pub. Date: Oct. 17, 2019

(54) Integrated Bike Lock

(71) Applicants: Justin Bawinkel, Indianapolis, IN (US); Dustin Ortega, Indianapolis, IN (US); Emma Rose Sloan, Indianapolis, IN (US); Melinda Joan Gieringer, Zionsville, IN (US); Casey Kauffman, Beech Grove, IN (US); Roman Dyagilev, Brownsburg, IN (US)

(72) Inventors: Justin Bawinkel, Indianapolis, IN (US); Dustin Ortega, Indianapolis, IN (US); Emma Rose Sloan, Indianapolis, IN (US); Melinda Joan Gieringer, Zionsville, IN (US); Casey Kauffman, Beech Grove, IN (US); Roman Dyagilev, Brownsburg, IN (US)

(21) Appl. No.: 15/952,621

(22) Filed: Apr. 13, 2018

(51) Int. Cl. E05B 71/00; E05B 73/00

(52) U.S. Cl. CPC E05B 71/00; E05B 73/0011

(57) ABSTRACT

An integrated bicycle locking device stored within the bicycle front fork assembly. The integrated bicycle locking device includes a baseplate having a mounting device configured to be attached to a steering tube of a bicycle that is to be securely coupled to a station, a lock cylinder mounted on the baseplate, having a lock pin key hole, and a locking member terminating in a lock pin and configured to pass through the steering tube, wherein the lock pin is further configured to be in a closed loop coupling with the lock pin key hole, and wherein the locking member is coupled to the baseplate.

### TECHNICAL FIELD

The present application relates to a bike locking mechanism, and more particularly to a bike locking mechanism that is stored in the bicycle steering tube. The invention involves a cable stored inside the bike steering tube. One end of that cable is coupled with a baseplate of a lock cylinder housing assembly, which is secured to the bike frame. The other end of coiled cable is coupled with a locking pin shank. The coiled cable can be extended out from the upper portion of the bicycle down tube. Extended coiled cable is wrapped around the bicycle parking rack or stand or any other object. The free end of the coiled cable coupled with a shank is inserted into a locking latch, which secures it in place. To release the shank, locking latch requires a key. Upon the release, coiled cable has the ability to retract back to its original length inside the bicycle steering tube. Shank end of the coiled cable also has a rubber collar that acts as a moisture barrier once fully inside the steering tube.

### BACKGROUND

The present invention relates to locking devices and more particularly to cable locks for securing a bicycle frame to a fixed object while being mounted inside the frame itself. The prevention of bike theft is an area of constant improvement. The common locks today are bulky, cumbersome, and forgettable. The goal of the lock mechanism is to be integrated into the bicycle steering tube to resolve some of these difficulties for the rider. As an integral part of the bike frame it cannot be forgotten, lost, cumbersome, or heavy. The rider will have a lock retracted into his steering tube available whenever it is needed. This type of lock also allows for the ability to sell bikes with pre-installed locks, so when a rider buys a bike he automatically gets a lock as well.

### SUMMARY

An integrated bicycle locking device stored within the bicycle front fork assembly is disclosed. The integrated bicycle locking device includes a baseplate having a mounting device configured to be attached to a steering tube of a bicycle that is to be securely coupled to a station, a lock cylinder mounted on the baseplate, having a lock pin key hole, and a locking member terminating in a lock pin and configured to pass through the steering tube, wherein the lock pin is further configured to be in a closed loop coupling with the lock pin key hole, and wherein the locking member is coupled to the baseplate.

The integrated bicycle locking device, wherein the locking member includes one of an expandable cable, coupled links, woven fabric, and a combination thereof.

The locking device, wherein the apparatus lock pin is metal and having a sealing device configured to fit the steering tube as a top cap that keeps the lock pin secure, as well as a moisture barrier while in storage.

The locking device, wherein the mounting device is coupled to the steering tube by radially expanding within the steering tube to provide a friction fit.

The locking device, wherein the mounting device is a coupled to the steering tube by one or more fasteners

A method of storing a locking device within the frame of a bicycle is also disclosed. The method includes providing an expandable locking member terminating in a lock pin within a front fork assembly of a bicycle, extracting the lock pin from the front fork assembly, passing the lock pin through or around a fixed object, and closed loop coupling the lock pin with a lock pin key hole of a lock cylinder coupled to the bicycle.

### BRIEF DESCRIPTION OF DRAWINGS

FIG. 1 is a schematic of the completely assembled bicycle locking device according to one embodiment of the invention;

FIG. 2 is a representation of the completely assembled bicycle locking device of FIG. 1 installed into a bicycle front fork assembly according to one embodiment of the invention;

FIG. 3 is a schematic of one embodiment of the lock cylinder housing assembly without any mounting apparatus attached to the baseplate of the assembly;

FIG. 4 is a schematic of one embodiment of the lock cylinder housing assembly including an expansion bushing, a threaded washer, and a threaded washer screw for mounting the assembly to the bicycle; and

FIG. 5 is a schematic of the lock cylinder housing assembly including the alternative mounting tab according to one embodiment of the invention.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure the term “about” can allow for a degree of variability in a value or range, for example, within 10%, within 5%, or within 1% of a stated value or of a stated limit of a range.

In the present disclosure the term “substantially” can allow for a degree of variability in a value or range, for example, within 90%, within 95%, or within 99% of a stated value or of a stated limit of a range.

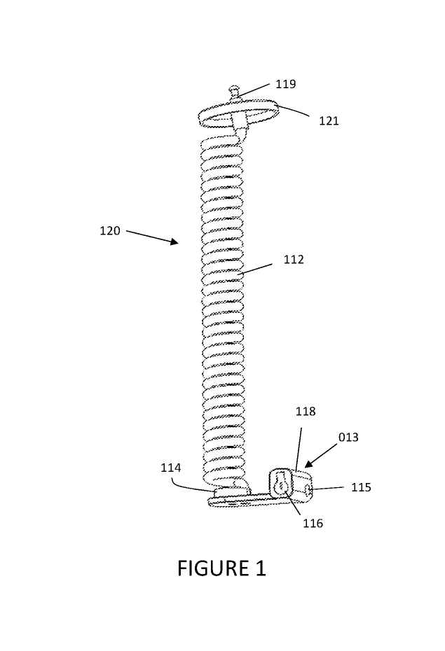

FIG. 1 illustrates an embodiment of the completely assembled integrated bicycle locking device 120. The assembly comprises of a lock cylinder housing assembly 013 which is connected to a lower end of a closed loop apparatus 112, comprising of but not limited to a coiled cable (also referred to herein as a locking member). The upper portion of the closed loop apparatus 112 is connected to a lock pin 119 and a seal cap 121 for preventing debris from collecting within the down tube 222 after the integrated bicycle locking device 120 has been installed on the bicycle front fork assembly 221.

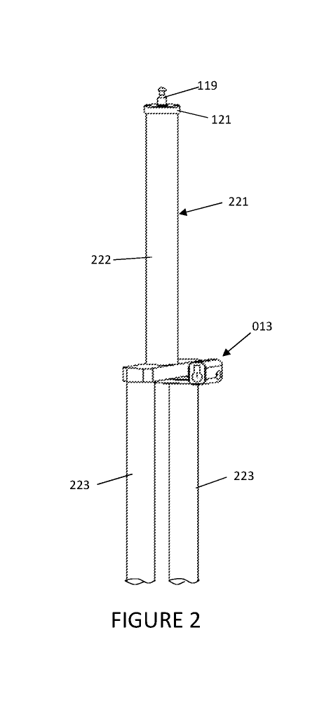

FIG. 2 is one embodied representation of the integrated bike locking device 120 installed on the front bicycle fork assembly 221. The integrated bike locking device 120 may be installed through the lower portion of the down tube 222 and in between the two wheel mount forks 223. For the integrated bike locking device to be positioned correctly during installation within the down tube 222, the upper face of the lock cylinder housing baseplate 312 should be positioned in contact with lower portion of the down tube 222, and the expandable bushing 114, having an outer diameter of about the same size as the inner diameter of the down tube 222, will be completely installed within the down tube 222. Once the integrated bike lock has been positioned correctly, the threaded washer 111 can be engaged to compress the expandable bushing 114 by tightening a threaded washer screw 117 thereby creating a friction fit between the expandable bushing 114 and the inner wall of the down tube 222.

For the closed loop apparatus 112 to have an effective length in securing the bicycle to a fixed object comprising of but not limited to a bicycle rack, the closed loop apparatus 112 should be coiled in a manner such that the outer diameter of the coiled cable it about the size of the inner diameter of the down tube 222 located on the bicycle front fork assembly 221.

Following the installation of the integrated bike lock device within the bicycle front fork assembly 221 as one embodiment of the invention is depicted by FIG. 2, the lock pin 119, seal cap 121, and closed loop apparatus 112 can be extracted from the bicycle front fork assembly 221 for the purposes of securing the bicycle to a fixed location. The lock pin 119 can then be inserted into the lock pin key hole 115 where the lock pin 119 engages the lock cylinder 116 to complete a secured closed loop. To release the lock pin 119 from the lock cylinder 116, a key may be inserted into the lock cylinder 116 allowing the closed loop apparatus 112 to recoil into the bicycle front fork assembly 221 for storage.

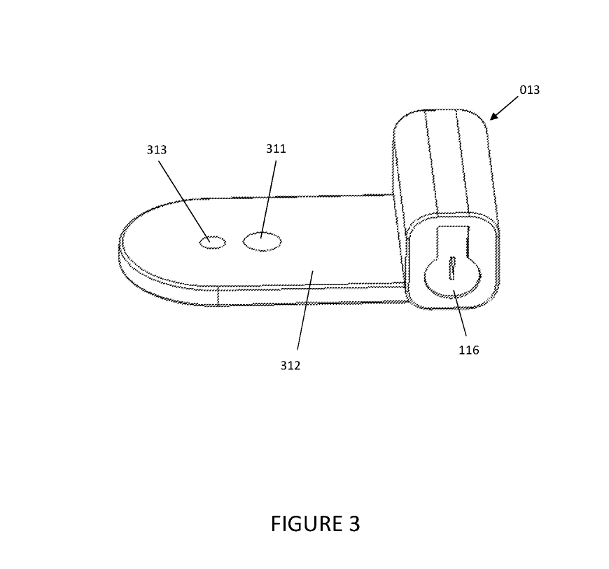

FIG. 3 illustrates one embodiment of the lock cylinder housing assembly 013 comprising of a baseplate 312, a lock cylinder 116 able to accept a key comprising of but not limited to a physical key or combination, a lock pin key hole 115 to insert and engage the lock pin 119, a closed loop apparatus mounting hole 311, and a screw hole 313. The lock cylinder housing assembly 013 is mounted to the frame of the bicycle.

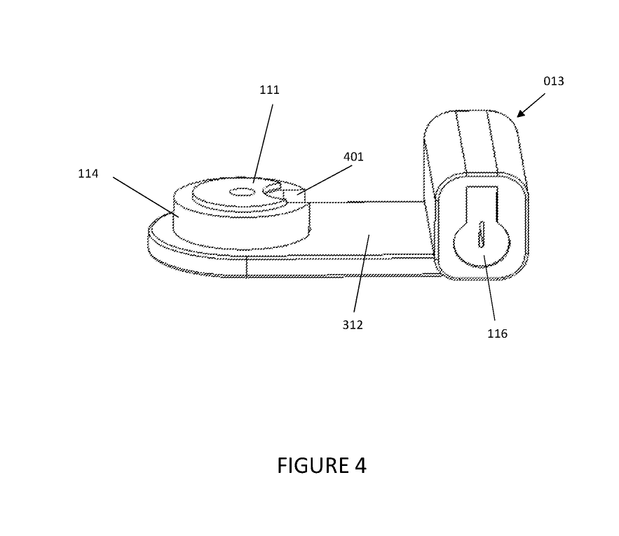

FIG. 4 is one embodiment of the lock cylinder housing assembly 013 including the addition of an expandable bushing 114, threaded washer 111, and threaded washer screw 117, being utilized as a modular mounting apparatus to attach the lock cylinder housing assembly 013 to the lower end of a bicycle down tube 222. The expandable bushing 114, threaded washer 111, and threaded washer screw 117 can be added modularly by placing the expandable bushing 114 and threaded washer 111 on the baseplate 312, directly centered above the screw hole 313. The threaded washer screw 117 can then secure the expandable bushing 114 and threaded washer 111 to the baseplate 312 by entering the opposite end of the screw hole 313 and threading into the threaded washer 111. As the threaded washer screw 117 is tightened into the threaded washer 111, the threaded washer 111 causes the expandable bushing 114 to expand creating frictional contact with the inner wall of the down tube 222. A recessed void 401 in the expandable bushing 114 allows for sufficient space of the closed loop apparatus 112 to be attached to the baseplate 312 via the lock cable mounting hole 311.

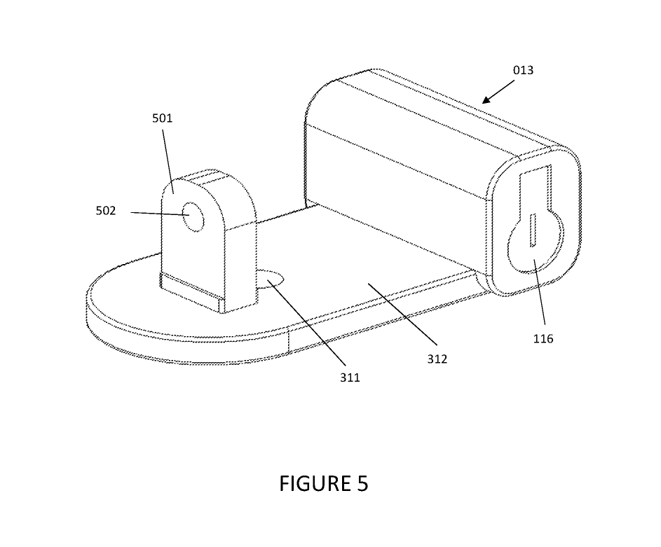

For instances where the down tube 222 does not have a sufficient inner diameter to accommodate the expandable bushing 114, FIG. 5 envisions one embodiment where the expandable bushing 114 can be replaced by a mounting bracket 501 in a modular fashion. The mounting bracket 501 can be assembled to the upper face of the baseplate 312 by centering the said bracket above the screw hole 313, while inserting the threaded washer screw 117 from the opposite end of the screw hole 313. The threaded washer screw 117 can then tightened thereby fastening the mounting bracket 501 to the baseplate 312. Following the addition of the mounting bracket 501 to the lock cylinder housing assembly 013, the closed loop apparatus 112 can be inserted into the down tube 222 of the bicycle front fork assembly 221. The mounting bracket 501 can then be secured to the bicycle front fork assembly 221 by inserting a threaded washer screw 117 into the mounting bracket hole 502 and utilizing the front brake caliper mounting bolt hole, commonly found on the bicycle front fork assembly 221.

Those skilled in the art will recognize that numerous modifications can be made to the specific implementations described above. The implementations should not be limited to the particular limitations described. Other implementations may be possible.

What is claimed is:

1. An integrated bicycle locking device stored within the bicycle front fork assembly, comprising;
a baseplate having a mounting device configured to be attached to a steering tube of a bicycle that is to be securely coupled to a station;
a lock cylinder mounted on the baseplate, having a lock pin key hole; and
a locking member terminating in a lock pin and configured to pass through the steering tube, wherein the lock pin is further configured to be in a closed loop coupling with the lock pin key hole, and wherein the locking member is coupled to the baseplate.

2. The integrated bicycle locking device according to claim 1, wherein the locking member includes one of an expandable cable, coupled links, woven fabric, and a combination thereof.

3. The locking device according to claim 1, wherein said apparatus lock pin is metal and having a sealing device configured to fit the steering tube as a top cap that keeps the lock pin secure, as well as a moisture barrier while in storage.

4. The locking device according to claim 1, wherein said mounting device is coupled to the steering tube by radially expanding within the steering tube to provide a friction fit.

5. The locking device according to claim 1, wherein said mounting device is a coupled to the steering tube by one or more fasteners.

6. A method of storing a locking device within the frame of a bicycle, comprising;
providing an expandable locking member terminating in a lock pin within a front fork assembly of a bicycle;
extracting the lock pin from the front fork assembly;
passing the lock pin through or around a fixed object; and
closed loop coupling the lock pin with a lock pin key hole of a lock cylinder coupled to the bicycle.
